(19) United States
(12) Patent Application Publication
(10) Pub. No.: US 2011/0304465 A1
(43) Pub. Date: Dec. 15, 2011

(54) SYSTEM AND METHOD FOR DRIVER REACTION IMPAIRMENT VEHICLE EXCLUSION VIA SYSTEMATIC MEASUREMENT FOR ASSURANCE OF REACTION TIME

(76) Inventors: Terrance E. Boult, Monument, CO (US); Rory Lewis, (US)

(21) Appl. No.: 12/980,899

(22) Filed: Dec. 29, 2010

Related U.S. Application Data
(60) Provisional application No. 61/291,266, filed on Dec. 30, 2009.

(51) Int. Cl. G08B 23/00

(52) U.S. Cl. 340/576

(57) ABSTRACT

A system and method for measuring impairment in an operator and stopping an impaired operator from operating a vehicle. The method empirically measures an operator's cognitive and motor skills requisite for safely operating a motorized vehicle and verifies the person's identity. The invention includes three interlocking major subsystems. The first subsystem provides generalized impairment measurement unit. The second subsystem interfaces with the impairment measurement unit and a vehicle ignition system and ensures the vehicle does not start if the operator is impaired. The third system determines whether the person blowing into a drug and alcohol analyzer connected to the first system is that person by detecting a various biometric. If the operator is not impaired and their identity is verified the vehicle ignition is enabled. If the operator is indeed impaired beyond a level requisite to safely operate the vehicle the ignition is disabled.

### RELATED APPLICATIONS

The present invention claims priority on provisional patent application Ser. No. 61/291,266, filed on Dec. 30, 2009, entitled “Driver Reaction Impairment Vehicle Exclusion Via Systematic Measurement of Impairment Level” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

The invention relates to preventing operators (hereinafter “operators”) from driving a motorized vehicle if they under the influence of alcohol or any natural or man-made drugs or even just severely fatigued. Driving while drunk or otherwise impaired is a very real problem in our society. In 2006, there were 42,642 people who died in a motor vehicle related accident (1). The causes of these accidents range from alcohol, to drugs, to inexperienced drivers, or simply being too tired to drive. How many of these deaths could have been prevented if the vehicles involved would only operate if the driver could demonstrate appropriate mental alertness?

Determining whether one is mentally alert or cognizant enough to operate a motorized vehicle is the essence of the invention. In a preferred embodiment, once the invention determines the aforementioned parameter it either allows the driver to turn on the engine of their motorized vehicle or it does not allow the driver to operate the vehicle for a set period of time at which time the operator may retake the test to determine his mental alertness. Regarding mental alertness in this patent, the document “A Literature Review on Reaction Time,” (2) is a compilation of discoveries from studies concerned with reaction times and the various external factors that cause them to change. Specifically, it makes a reference to the study done by Welford in both 1968 and 1980 where the effects of fatigue were shown to slow the reaction time of the individuals tested. In addition to these findings, “Van den Berg and Neely (2006) found that sleep deprivation caused subjects to have slower reaction times and to miss stimuli . . . ” In addition to the fatigue studies, others were conducted in relation to age, alcohol, drugs and various other factors. Since these reactions can be measured, there is a way to monitor and evaluate someone's mental alertness. While multiple states have laws related to Driving Under the Influence of Drugs (DUID), there is no field device for testing drugs other than alcohol, and no interlock devices designed to limit operation for drugs other than alcohol.

Of the systems present wherein an interlock device is connected to an ignition system of a vehicle and to some sort of impairment evaluation system there is no system by which a operator cannot have a third party perform the breathalyzer test or enter a password or perform any of the unsecured means of allowing a third party to perform the duties of an impaired person to therein trick or deceive the interlock system connected to the ignition device. The invention presented herein provides both novel means to test the biometrics of the operator in a manner above that of the existing art. And secondly but most importantly the present invention provides a non trivial, non obvious means of preventing any third party from performing said operators biometrics unless said third party is the operators biometric twin. Even in the case of the twins, multiple biometrics will probably separate twins in the hypothetical scenario presented above.

Our society would benefit considerably if teenagers, DUID offenders, parolees from drug convictions and other selected operators were only allowed to drive if they could prove, immediately, at that point in time that they are in a condition to drive. Even though the art provides blood alcohol driving interlock mechanisms that stop chronic drunk drivers from starting their cars, they all bear at least one property that has not made these devices become a part of our society. The proposed invention would address all issues mentioned.

Systems for testing subjects for response to stimuli are known in the prior art. These are not mobile devices for field use, nor are they interfaced to vehicles. None of presently known systems are able to provide both
an absolute guarantee that the person who says they are taking the test is indeed that person or that the results of the test are the results of that person's, or/and
an accurate assessment of an operator's perceptual, cognitive and motor ability to operate and vehicle and then prevent or allow that operator from operating said motorized vehicle.

We present a system wherein the person who is supposed to be taking the test is absolutely that person. In this section we present the closest art to the present invention in order of significance all of which are unable to prevent a third party from usurping the neuropsychological, biometric or breathalyzer portions of the referenced art here under.

White et al's application number 2007/0239992A1 provides a subset of the present invention that relates to a method and system for preventing unauthorized use of a vehicle or device by an operator or the vehicle or other device. White provides a means to connect biometric and breathalyzer data to an ignition device. However, the fingerprint system can easily be spoofed and the facial recognition system is not correlated to a distance metric thus providing a means for an operator to easily trick the device by first spoofing the fingerprint device presenting a photograph to the facial recognition system and having a third party blow in to the breathalyzer. The present invention provides a slap fingerprint system that renders spoofing impossible while White et al's system leaves the door open to spoofing. Furthermore, the present invention provides facial recognition that guarantees that the face in front of the camera is a three dimensional moving image of the operator and finally the blue tooth device of the present invention has a map of the signal analysis generated from the back of the system to inside that particular operators mouth making only that operator biometric twin be the only third party capable of tricking the present invention.

Osten et al's U.S. Pat. No. 5,719,950 provides a subset of the same problem by measuring a non-specific biometric parameter of a physiological characteristic value then preventing the operator to operate the vehicle if that value is outside of normal range. The non-specific biometric parameter is selected from the group consisting of pulse rate, electrocardiographic signals, spectral characteristics of human tissue, percentage oxygenation of blood, bloodflow, hematocrit, biochemical assays of tissue, electrical plethysmography, transpiration of gases, electrical property of skin, blood pressure, differential blood volumes, and combinations thereof. The 950 patent teaches an approach for directly measuring properties related to alcohol in the blood, but would required different processes for each potential drug or source of influence. In contrast, the proposed invention uses neuropsychological measurements in a mobile generalized impairment system to assess cognitive impairment and reaction time, rather than a physiological measurement of potential drugs, and so a single test applies across all sources of impairment. Additionally, Osten et al's invention is rendered useless if the somebody else's biometrics are taken, other than the driver. Conversely, the present invention determines that only the person that is going to operate the vehicle is indeed the person being tested.

Hale et al's U.S. Pat. No. 6,920,389 provides a subset of the same problem measuring reflex times or impaired motor skills and prevent an impaired operator from using the vehicle. The 389 system teaches of an invention wherein “vehicle function systems are energized according to a predetermined sequence” as a means of both security and potentially measuring impairment. The sequence of actions acts like a combination-lock, with a preset time to complete the activities. There is no display or input from the system to the operator on what to do, only the measurement of a predetermined sequence of activities the operators must remember and an optional display of when various stages of the activity have been achieved. The 389 approach is clearly impacted by training and practice, and lack a research basis that might allow the use of its measurements/scores in court. The proposed invention is different in that it does not include a pre-determined sequence of actions but rather uses a computer generated sequence of tests. Thus, the operator does not have to remember the sequence and training has little impact on the testing. In addition, the neuropsychological tests in the present invention are based on published scientific research and can be calibrated, validated for use in court and can be individualized. The proposed invention has an externally determined “policy” mechanism allowing adaptive testing. In addition, the optional biometric identification adapts the testing to individual operators and can verify that only an authorized operator can operate the vehicle.

Edmonds et al's U.S. Pat. No. 6,229,908 provides a subset of the same problem because it solves a subset of the same problem by measuring a value related to blood alcohol then preventing the operator to operate the vehicle if it is above threshold. To reduce the potential stigma, the measurement mechanism is under the driver's seat. The proposed invention is different in that it does not measure blood alcohol, but measures cognitive and motor skills which are to driving ability

Victor et al's 20070132950 patent application provides a subset of the same problem because it provides a suitability test with respect to perceptual impairment of a driver or other equipment operator by analyzing ocular performance while an operator is driving a vehicle. The proposed invention is different in that it does not measure ocular biometrics but rather compares a base-state of various neuropsychological test of the operator is in before they start the vehicle. The neuropsychological tests measure a broader range of impairment effects. In addition, different people have different base states and ocular data is neither the same across all operators, nor is it an indicator of certain chemical drug influences.

Komlos et al's U.S. Pat. No. 4,723,625 provides a subset of the same problem providing a device which determines an operator's “reflex-alertness” and consequently makes use of this test data to compare it to the, medically expected, neurological correlation of reflex deterioration upon intoxication, barbiturate use or emotional stress. The proposed invention is different from Komlos which neither establishes whether the operator taking the test is indeed the operator who is about to operate the vehicle, nor does it stop the vehicle from starting.

Also Komlos provides one testing system that an operator, if he were to take the test when not sober and have somebody take t for him, could learn. The proposed invention identifies an operator as being the operator sitting in the seat and about to drive the vehicle, it does not allow the car to start if the operator moves, tries to disable the device, tries to trick the device, tries to get somebody else to take the test, or blow into a device, or help them take the test or if the driver simply fails the tests provided. Furthermore the present invention provides a randomized test that changes and can never be learned by the potential driver.

Bouchard et al's U.S. Pat. No. 5,465,079 provides a subset of the same problem because it uses a radar to evaluate a driver's performance under actual real-time conditions and for using such evaluations to determine the driver's ability to safely operate a vehicle compares the information gathered by a radar system and other GPS-type sensors with information previously stored in an event recording device. Conditions monitored are used to make a determination as to whether the driver is performing in conformity with normal driving standards and the driver's own past performance. The driver's performance is constantly monitored and compared to that driver's past performance to determine whether the driver's present performance is impaired, and if so, whether the impairment is detrimental to the driver's ability to safely operate the vehicle. The system focuses on the vehicle, not the driver. The proposed invention focuses on the human condition, in determining whether that human's condition is impaired enough that it should disable the ignition system not the speed at which the vehicle moves or sways on the road.

Metalis et al's U.S. Pat. No. 5,798,695 provides a subset of the same problem because it provides an impaired operator detection system for detecting impairment of an operator of any equipment, system, or vehicle which requires continuous compensatory tracking, or nulling, of course deviation error. Operator control actions are characterized as a complex sine wave and then a power spectrum array (PSA) analysis is used to characterize this control action data. Statistical techniques are used to predict the level of operator alertness by comparing the analysis results of the operator's recent control actions to empirical power spectrum array (PSA) analysis data indicative of an unimpaired operator. Again as in the Bouchard et al's 079 the system focuses on the vehicle, albeit differently from Metalis, not the driver. Metalis et al fails to prevent an impaired operator from driving the vehicle because it only detects the state of the driver when the vehicle is already driving down the road possibly killing somebody before the detection system calculates the state of the driver.

Collier et al's U.S. Pat. No. 4,738,333 provides a subset of the same problem because it provides a sobriety interlock system that prevents a vehicle or other equipment from being started unless the identity of a designated operator is confirmed by the system and the operator passes a breath sobriety test. However, the system does not know if the operator himself is taking the test. Indeed, the operator can be inebriated and ask another operator to take the breathalyzer and enter the identification code. The proposed invention cannot be tricked by having a 3rd party perform tests and it also provides the ability to detect more than just alcohol consumption. The proposed invention knows who is taking the test and does not permit ignition of the motor vehicle regardless as to what 1) is negatively affecting cognizance or 2) how inventive the inebriated operator tries to trick the system.

### BRIEF SUMMARY OF INVENTION

The present invention is related to transforming neuropsychological test responses and timing on a mobile device into a measure of impairment and in the preferred embodiment using the measurement to improve vehicle safety. The concept of the Driver Reaction Impairment Vehicle Exclusion via Systematic Measurement for Assurance of Reaction Time (hereafter referred to as DRIVESMART) is motivated by the need for stopping drivers that do not have sufficient mental alertness to operate a moving vehicle. Breathalyzers can only measure alcohol, but there are many other forms of impairment. Neuropsychological tests are specifically designed tasks used to measure a particular cognitive function and can detect many types of impairment. Aspects of cognitive functioning that are often assessed include visuo-perception, and executive-functioning, orientation, new-learning/memory, reasoning, and language.

The present invention addresses the limitations of previous inventions by developing a mobile measurement unit which employs neuropsychological and cognitive measures in a set of impairment test and transforms the measurements of cognitive and motor skills into an overall impairment score. It can interact with the vehicle to ensure that the driver (hereafter “operator”) may only operate a motor vehicle when the system deems that the operator's mental alertness is above a predetermined threshold. The invention evaluates the driver's impairment using a less expensive system that detects impairment over a wider range of potential influences, authenticates the person being tested and does so with no apparent change to the appearance of the vehicle and thus prevents DUI without social stigma.

### BRIEF DESCRIPTION OF THE SEVERAL VIEWS OF THE DRAWINGS

FIG. 1 is the sequence of the proposed system where the initial step has administrators, parole officers, rehab mentors, parents or otherwise concerned parties setting up the system wherein they follow installation instructions to set up the hardware system on the vehicle and then install the impairment measurement software on the chosen and already present display device, such as, but not limited to, a GPS unit, smart phone or other device capable of interaction with operators and other modules associated with the system. The administrator has the option of inputting and setting a variety of parameters related to each driver that needs to be monitored. Several such driver profiles can be created. These parameters, settings, and profiles can be edited at any time by the administrators. When the system is in operation, the driver turns the ignition key to the accessory position and is then prompted on the display device to complete a series of evaluations. Upon completion, a score is computed by the impairment measurement unit as to whether the driver has the necessary cognitive function, reaction time and alertness to operate the vehicle. This score is sent to the hardware device, called the vehicle disabling unit, and this unit either allows the vehicle to start, or continues to disable it.

FIG. 2 comprises a preferred embodiment of the impairment measurement unit which includes an embedded device with a lightweight GUI library suitable for embedded devices with limited processing capacity such as PDA, cell phone, GPS navigation unit, etc that may be selected to drive the operator interface. The impairment measurement unit uses the interface to present stimuli and obtain operators response to those stimuli and then transforms them into a level of impairment score. The impairment measurement unit may control the operator's access to the system through a variety of means including but not limited to password verification, biometric authentication such as finger print scanning, or temporal biometric measurements etc. In one preferred embodiment, the measurement unit communicates with the vehicle disabling hardware unit through wired or wireless medium.

FIG. 3 is an option for the operation of the interlock hardware if wireless where the impairment measurement unit portion of the system communicates with the hardware unit via a Bluetooth, or other wireless or wired protocol. The measurement unit sends the interlock hardware a signal either saying that the vehicle may operate or that the vehicle may not operate. In the preferred embodiment, upon receipt of this signal, the hardware responds to the impairment measurement unit with an acknowledgement of receipt or an error message. If the message is received successfully, the interlock hardware either engages or continuing to disengage the operation of the vehicle using a power switch-like device such as a transistor, solenoid or relay. Possible reasons why the measurement unit might receive an error message from the interlock hardware would be if the hardware is missing or not functional, or if something is preventing the hardware from disengaging the operation of the vehicle. The system uses the feedback to diagnose operator and other system errors.

FIG. 4 is another option for the operation of the interlock hardware where a different method of communication between the impairment measurement unit and the hardware is used.

FIG. 5 is a preferred embodiment of the Location Verification Unit illustrating the information transfer of the Location Verification Unit authorizes the use of the program by utilizing signal strength

FIG. 6 is another preferred embodiment of the Location Verification Unit where rather than depend on signal strength, the system utilizes weight sensors already found in the vehicle to determine location of operator/driver.

FIG. 7 is a blocked diagram of the DRIVESMART system showing connections between the display unit, the universal application and the disabling device and it's interconnections.

FIG. 8 is a preferred embodiment showing the first system connected to the second system with an operator performing the finger measurements on the first device and blowing in to the second device.

FIG. 9 illustrates how the present invention can either operate singularly with only the first device or in the preferred embodiment wherein the first device is connected to the second device.

FIG. 10 illustrates a preferred embodiment of the invention wherein a 3rd party with requisite authority has an operator have the present invention take the operator's biometrics which are transmitted to the appropriate law enforcement of guardian persons.

FIG. 11 illustrates a preferred embodiment of the invention wherein an operator's biometrics control both the engine ignition and the transmission of the operator's impairment level rendering the vehicle unable to start and a possible evidence of intoxication.

### DETAILED DESCRIPTION OF THE INVENTION

DRIVESMART as two key elements: a mobile impairment measurement unit that interfaces to a vehicle interlock to ensure vehicle is disabled when the operator/driver's ability to operate the vehicle is deemed impaired. This system includes but is not limited to a vehicle-disabling unit, a location verification unit, as well as an impairment measurement unit to analyze the operator/driver's ability to operate the vehicle. The impairment measurement unit interacts is itself a novel element, transforming simple measurements from the operator/driver using a display device, such as, but not limited to, a GPS device, a cell phone, or even the car stereo, into an impairment score. The impairment measurement unit evaluates the operator's ability to operate the vehicle and upon analysis communicates with the vehicle-disabling unit to allow or disallow the vehicle to operate. Similar to a usage of portable breathalyzer for alcohol measurements and random drug testing, a portable impairment measurement unit has direct applications independent of the interlock, allowing for third party measurements and monitoring of individuals at risk for inappropriate use of undue impairment at work or home.

The time it takes for the driver to react to a given situation can be the difference between a life or death outcome. While an operator is in a state of driving under the influence, driving while sleepy or driving with other mental impairments, it is found that there is a significant decrease in reaction time and therefore a substantial decrease in safety. While basic reaction time, e.g. time between a stimulus presentation and operators hitting a button, might be used in simple embodiments, research suggests it is a weaker predictor because of its inherent variations. A driving simulator is useful for measuring driving impairment, but requires more complex and costly hardware to provide interfaces for measurement and because of their inherent multi-dimensional complexity produce significant variances in measurements that limit their sensitivity. Preferred embodiments of the invention would use a mobile device such as a phone with a combination of simpler and more sensitive measurements including divided attention tasks, selective attention tasks and cognitive tasks to evaluate the level of possible impairment as they showed increased sensitivity in laboratory testing, especially for low-dosage testing. By taking the driver through one or several impairment measurements tests and comparing with a baseline performance, a driving capability assessment can be determined. While many neuropsychological tests for measuring physiological and cognitive impairment are widely used in laboratory settings, those skilled in the arts will see how to adapt some of them for mobile device usage as in this invention. Examples of such well known tests would include various forms of Digit Symbol Substitution Test, Stroop-like tests, continuous performance tasks, multi-body tracking, maze tests and verbal tests such as sentence verification, e.g. see references (3)(4)(5)(6)(7). The divided attention task have the advantage of being directly related to National Highway Traffic Safety Administration reports (8)(9) and standard field sobriety tests, but the invention would be replacing the subjective analysis of an officer with a more objective computer-based measurements. Some of these neuropsychological tests are easily adapted to a small mobile device, ideally with a touch-screen, for mobile/in vehicle measurement, e.g. yes/no digit symbol substitution tests or numeric-response versions are easily done on almost any mobile phone or GPS unit. Having a unit that supports a combination of different tests has the advantage of allowing for capturing a larger range of potential factors, and decreasing habituation and boredom. It does complicate the potential need for baseline data for comparison. Those skilled in the art will be able to start from the laboratory tests and scores, adapt them to the embedded devices interface and then calibrate the resulting transformed scores against levels of influence. In one embodiment, the measurements would be transformed into an absolute standard score, similar to an estimated Blood Alcohol Concentration (BAC). An absolute standard score allows a patrol officer to test an individual they have never met during a roadside test. Absolute score transformation would use a population-based calibration of the responses and could be based on past research or regular calibration procedures. However an absolute standard does not directly say how an individual is impacted, e.g. it is well know that different people with the same BAC may have measurably different reaction time and coordination skills. One of the contributions of this invention is that by having a personal mobile device for the measurements, the system can use baseline measurements to calibrate to a particular individual which will makes the test more accurate in measuring impairment. In the preferred embodiment, the impairment measurement would be using a person-specific baseline allowing it to adjust for individual variations and hence be a more accurate and sensitive test. This could still use population-based calibration, e.g. for transforming the results to an approximate BAC scale, but now would include the baseline measurements into the transform, e.g. subtracting the individual baseline score rather than the population baseline score before normalizing the scale. Those skilled in the art of biometric and medical measurements will recognize many transforms that may provide effective normalizations using such per-person, baseline and contextual data. While the neuropsychological tests offer new and important advantages, there are still many advantages of existing physiological measures such as breathalyzers, such as their long established validity in court, thus an embodiment that combined the two types of tests, as well as elements to authenticate the identity of the individual being tested and resist tampering, would offer a substantial advance of the current art.

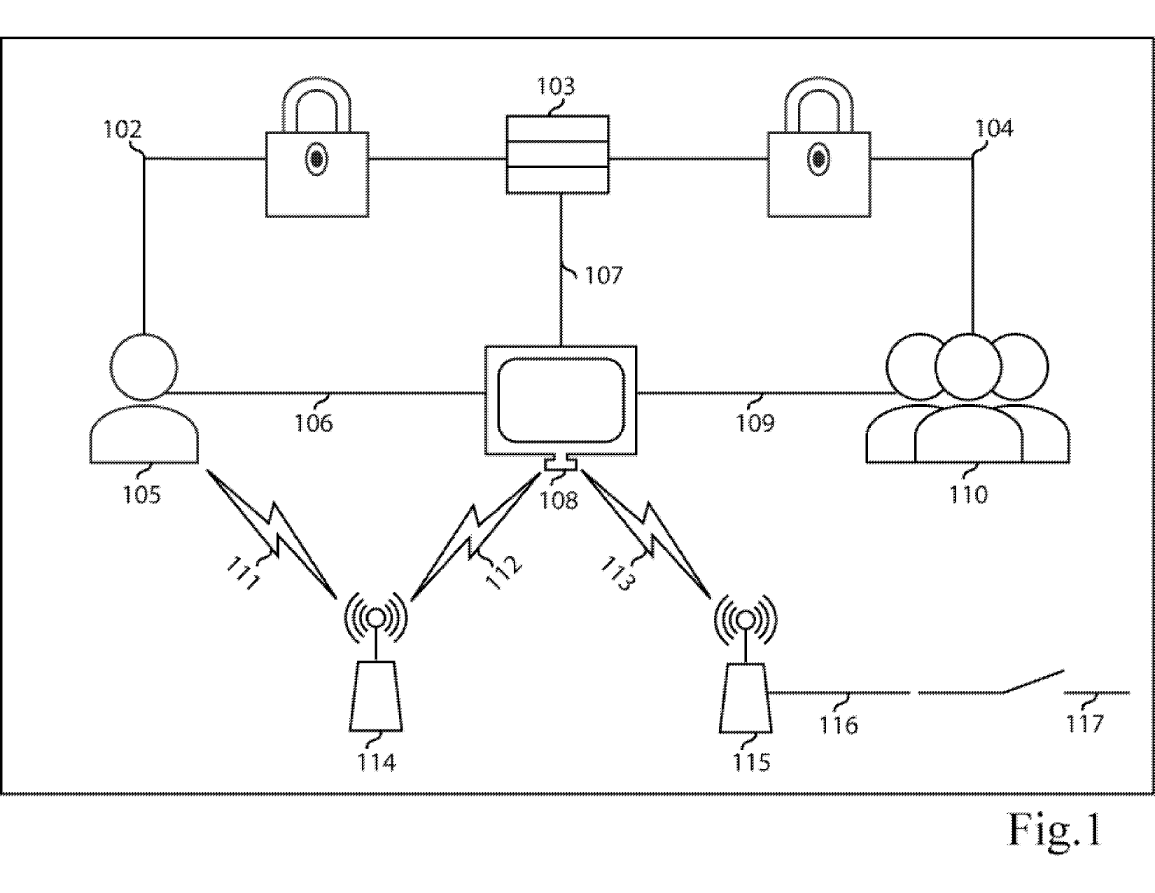

FIG. 1 illustrates the overall concept wherein the driver 105 begins to initialize operation of the vehicle, such as turning the key to the accessory position, in order to provide power to the display device and the vehicle-disabling unit. The display device 108 would then step the driver through a series of impairment measurement tests 111, 112, ideally in the form divided attention measurement or game, during which the operator must respond to various sensory cues. The operator could interact with the impairment measurement unit using a variety of options, including but not limited to the buttons found on the display device, a touch-screen or the steering wheel and pedals 106. The unit would transform the responses and the time difference between stimulus and response (i.e. reaction time) into an impairment measurement. The unit could transmit and report the captured measurement to a third party (e.g. a traffic officer) or optionally use it to make a decision about whether the vehicle is be operable or inoperable 113. This decision is then sent to the vehicle-disabling unit 115, which either allows the vehicle to operate 117, or continue to stop it from operating 116. In the preferred embodiment, prior to usage the system would be installed, setup and calibrated for a specific set of operators. The administrator 110, follows step-by-step instructions for the installation and setup. The administrator could be parents or other concerned parties who want to control the parameters of the system. After the hardware has been installed in the vehicle, and the impairment measurement unit has been installed on the chosen display device, measurement thresholds and settings are set 107. The measurement thresholds can be input from the administrator and a different profile can be given to each driver. In a preferred embodiment, the system continues to monitor timing for each designated operator and uses a measure based upon the deviation from the best performance of that operator. For initialization the measurements can be based on administrators' usage of the device, with error bounds defined by the administrator. Learning the parameters during installation, from the intended operator has the potential to allow them to intentionally set slow parameters so as to enable them later drive under the impairment and should be avoided. In yet another preferred embodiment of the present invention, to increased flexibility of use, it presents means to enable an administrator to define a schedule of times wherein selected levels of reaction time testing is required, including the potential to schedule times when testing is unnecessary and hence the vehicle directly starts. This would allow for even further reduced social stigma, e.g. saying a particular vehicle can start without need of alertness testing from 7 am to 5 pm, but any other time may require testing. In another preferred embodiment of the invention, scheduling can further be enhanced to use geo-spatial rules, e.g. the vehicle can start without testing at specific locations such as at home or a school parking lot specified by utilizing the GPS capability (if any) of the display device, but requires reaction time testing anywhere else. The administrator possesses a digital passkey 104, which can be used to bypass the impairment measurement unit evaluation, and edit settings 103. In essence, every portion of the system interacts. 103 is the proprietary impairment measurement unit with software that runs on the control unit 108 via the operating system 107. The impairment measurement unit 103 goes through authentication 102 and 104 to determine the operator 105 or 110 to allow certain functions to either the administrator 105 or restrict certain functions to the end operator 110, 106 and 109 are the physical interaction between the administrator 105 and/or the end operator 110 with the control unit 108. The control unit 108 communicates with the vehicle disabling unit 115 via 113 who's preferred implementation is wireless. The vehicle disabling unit 115 interacts with an electrical switch 117 to control the ignition via connection 116.

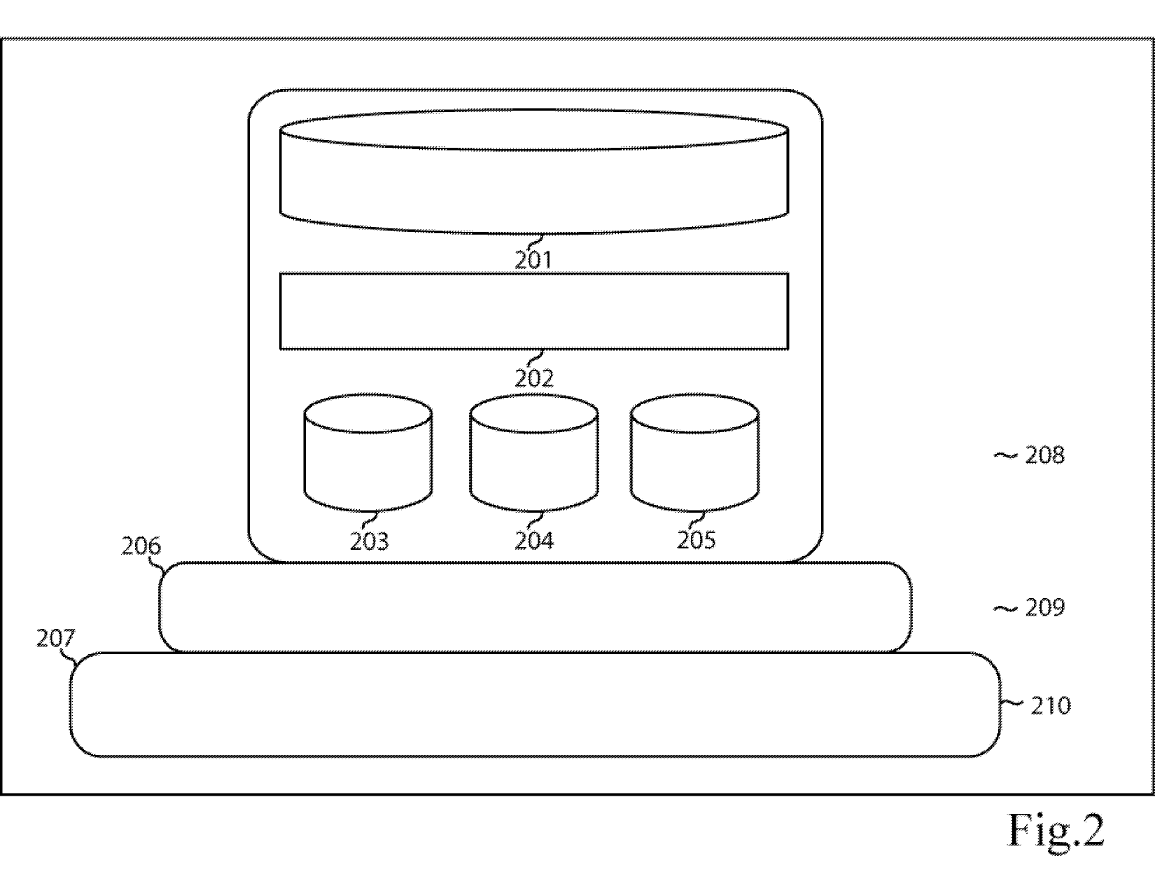

FIG. 2 describes the various portions of the system. 208 is designated as the impairment measurement unit of the system. It consists of the graphical user interface (GUI) 201, which is followed by an optional authentication portion 202. After authentication 202 is determined, there are three tertiary systems the scoring unit 203, file system 204, and the communications systems 205. The impairment measurement unit 208 runs on top of an operating system 209. The preferred system of use is a robust embedded system OS such as Linux or IOS 206 for the operating system 209. All of the impairment measurement unit transforms/software 208 and 209 need a hardware environment 210 on which to execute. In a preferred embodiment 210 is an the embedded device 207 that the operating system 209 and proprietary impairment measurement software 208 are stored and run on. The scoring unit 206 contains the tests/games designed to measure the impairment of the operator. It chooses the test to use, displays the stimuli, receives the responses/timing and transform them into an operator impairment score The file system 201 stores information about various operator profiles and response measurement parameters set by the administrator. The communication module exchanges information with the vehicle-disabling unit, the location verification unit and/or the weight sensors utilizing a wired or wireless medium. The authentication module 202 controls the access privilege of the operator. Authentication is achieved in a variety of ways including but not limited to password verification, biometric authentication, etc. In preferred embodiments where it is important to ensure that the operator playing the game or doing the impairment measurement test is the driver, the measurement unit communicates with the weight sensors to find out whether the driver's seat is occupied or not 208. The impairment measurement unit furthermore communicates with the vehicle-disabling unit and the location verification unit both of which are housed inside the vehicle to triangulate the position of the operator being tested based on the wireless signal strength measurements 209. In some preferred embodiments, if either the driver's seat is not occupied or the user using the impairment measurement unit is not located in the driver's seat area, the impairment measurement unit notifies the operator that the test/game cannot start unless the driver is in the seat, and the test/game starts only if both the conditions are satisfied 210. In another preferred embodiment of the present invention the impairment measurement unit comprises of graphical operator interface (GUI) 207, authentication 200, scoring unit 206, file system 201 and communication modules 203, 204, 205. The communication system might include any form of electronic communication including but not limited to text message, email, invoke a cell phone service, a Large Area Network (LAN), a Wide Area Network (WAN), a wireless service, an intranet or an internet type of service. This communication can then allow the unit to alert a guardian, spouse, family member, partner, addiction counselor, police officer, parole officer, magistrate, judge or predetermined person to communicate that the operator may be in violation of court orders, state laws, federal laws or other terms agreed upon with said operator's guardians or mentors.

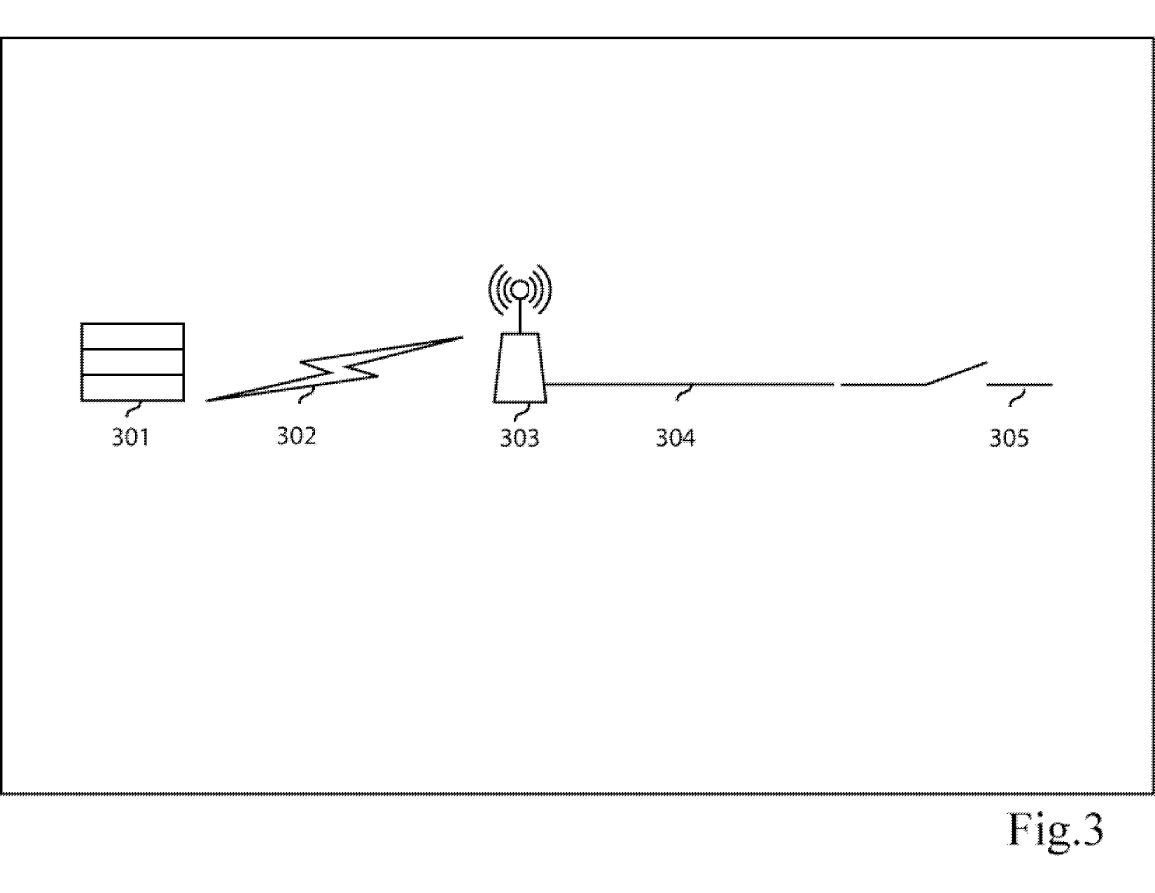

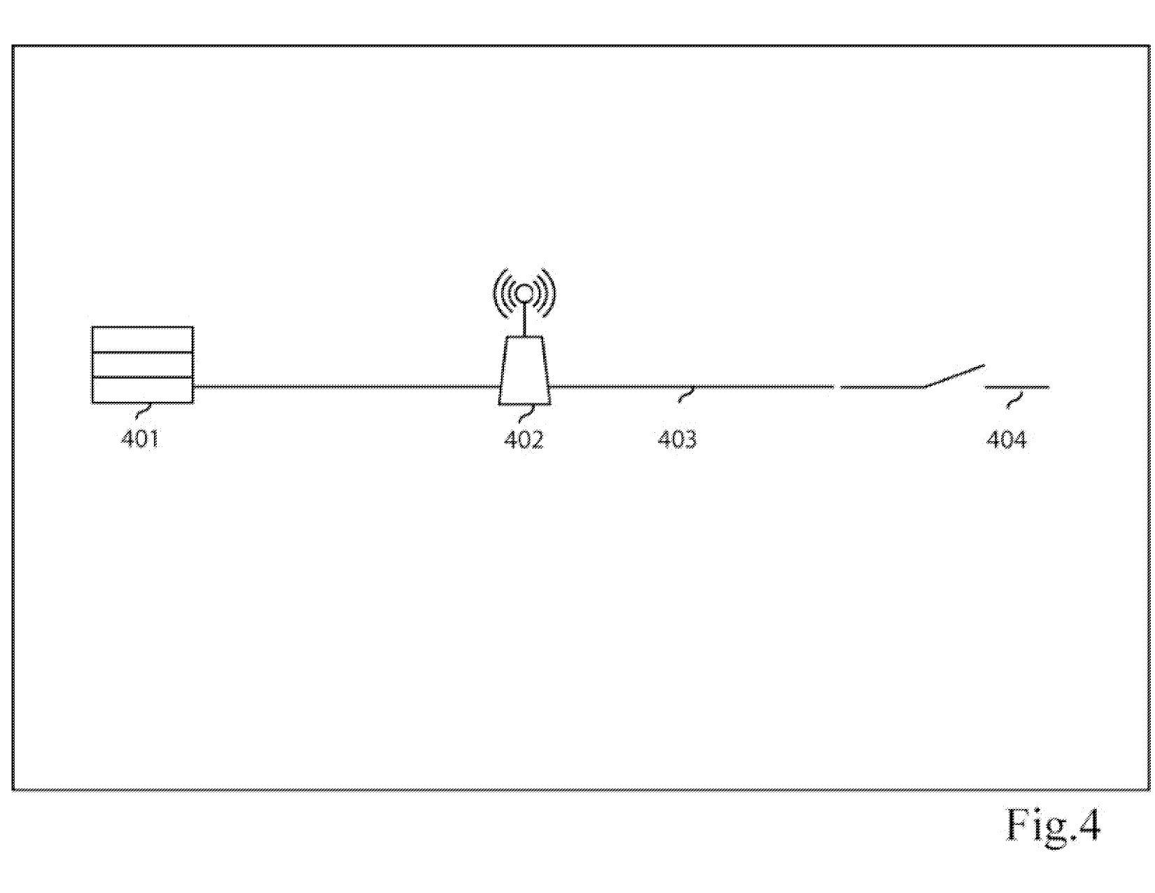

FIGS. 3 & 4 illustrate the hardware unit itself 301, 401 that comprise a control unit 303, 402, location verification unit 304, and switch circuitry 305, 404. The control unit may be wired or wireless 302 (via Bluetooth or other wireless protocol) and have control circuitry. This portion of the device acts as a slave to the device on which the impairment measurement unit is installed. FIG. 3 primarily describes an additional embodiment wherein a wireless connection is utilized. 301 is the impairment measurement unit of the system that communicates wirelessly via 302 to the vehicle disabling unit 303. Upon reception of the signal the vehicle disabling unit 303 controls a toggle switch 305 via a wire connection 304. FIG. 4 primarily describes another embodiment of the invention wherein a wired connection is utilized. 401 is the impairment measurement unit of the system that communicates directly to the vehicle disabling unit 402. Upon reception of the signal the vehicle disabling unit 402 controls a toggle switch 404 via a wire connection 403.

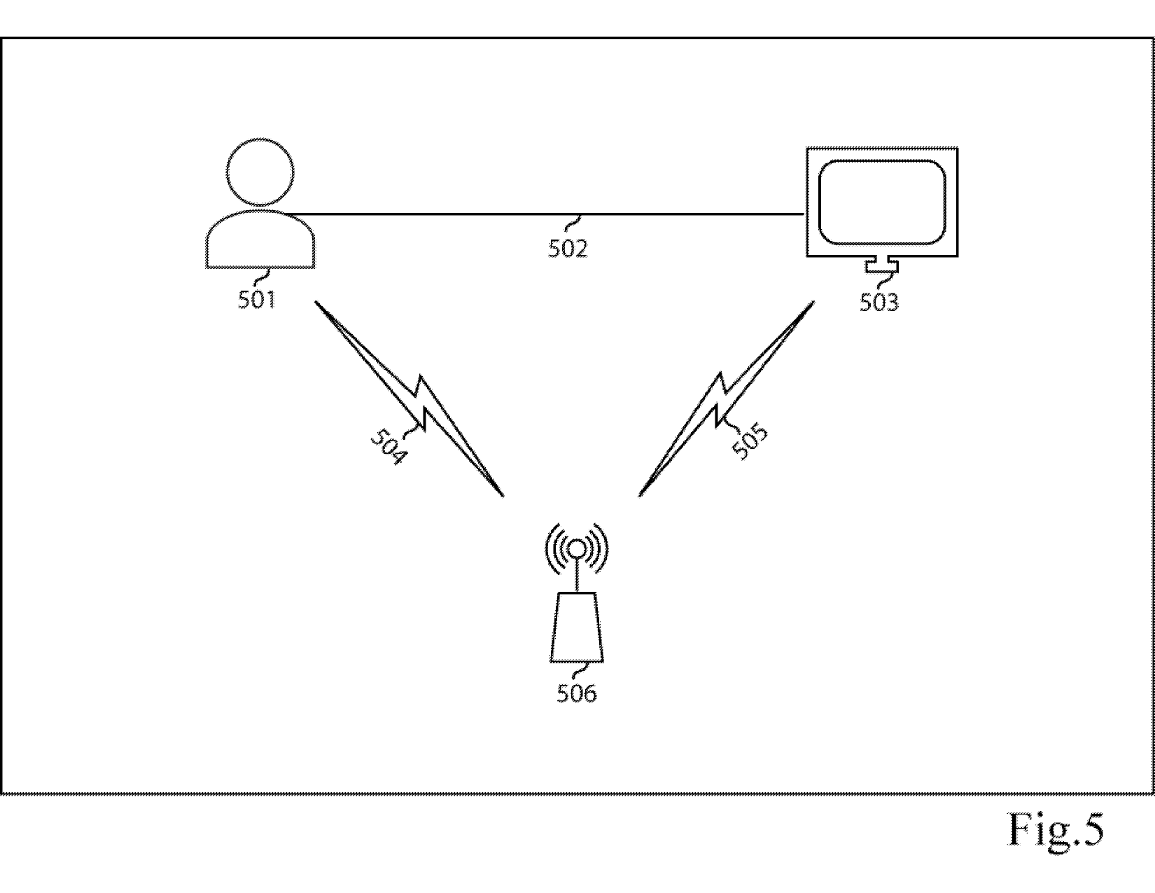

FIG. 5 illustrates interactions between a human 501, the control unit 503, and the vehicle-disabling device 506. 502 indicates a physical interaction between 501 and 503. 505 indicates a wireless connection between the control unit 503, and the vehicle disabling device 506.

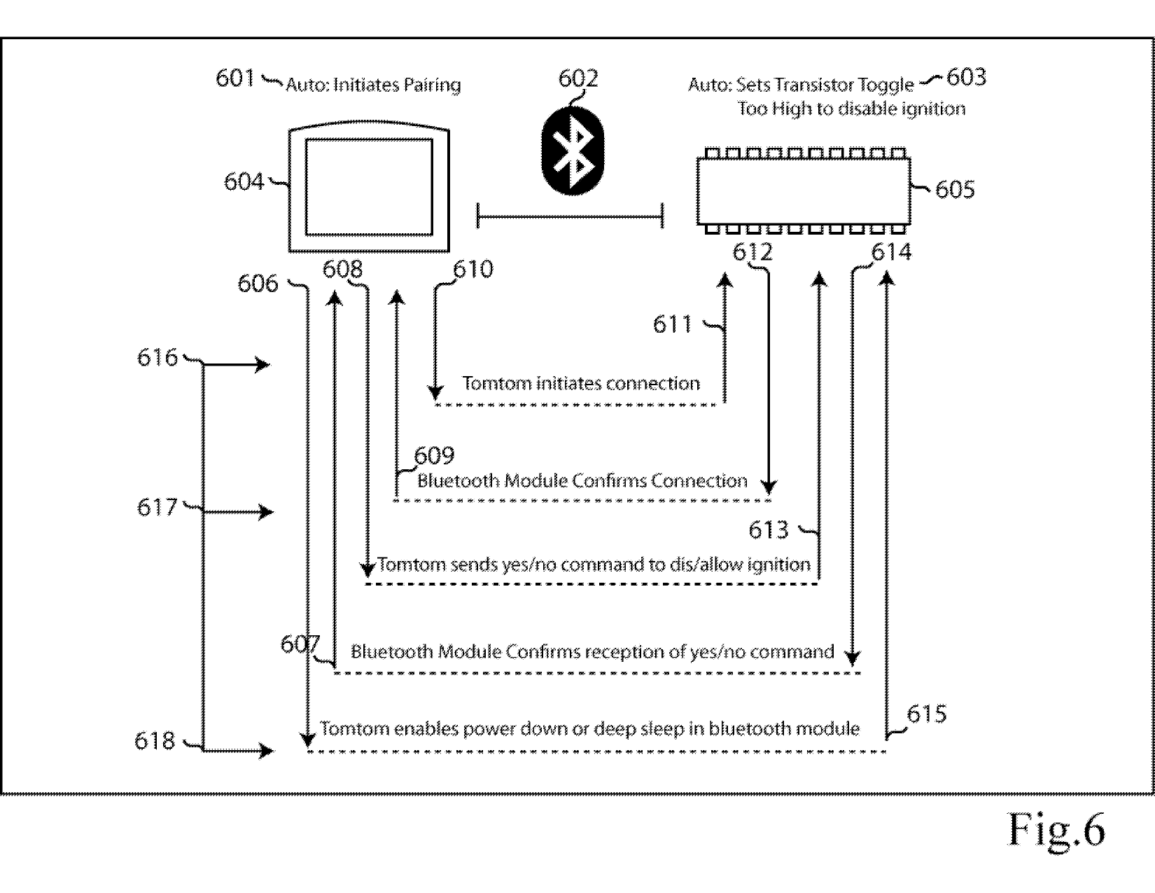

FIG. 6 illustrates interactions between the control unit 604 and the vehicle-disabling unit 605. The system confirms whether all transmissions have successfully been sent and/or received. All data interactions are performed via a wireless connection of 602. Our preferred embodiment incorporates Bluetooth as the preferred method for this implementation. All communications are wireless and can be found in item numbers 606 to 618. 610 and 611 are the initial transmissions sent by the control unit 604 to the disabling unit 605 to begin the test. 612 and 609 are the reply from the disabling unit 605 to the control unit 604 to confirm transmission sent in 610 and 611. After the test has been completed on the control unit 604 it sends a signal, to the disabling unit 605, that will allow or disallow the vehicle to start through 608 and 613. The wireless module on the disabling device 605 sends a confirmation of the “allow” or “disallow” command 607 and 614. After the final confirmation is completed, 607 and 614, the control unit transmits a signal 606 and 615 that puts the disabling unit 605 into a low power or “sleep” mode. Item 601 dictates what is to happen when the control unit 604 is turned on, for this implementation, it is to initiate paring. These commands are noted above in items 606 to 618. Item 603 dictates the resulting process when the disabling unit 605 is turned on. For this implementation the first instruction 603 is to disable the vehicle ignition. The area between 616 and 617 indicates the initial pairing of 604 to 605. The area between 617 and 618 illustrates the area where commands for disabling the vehicle are found.

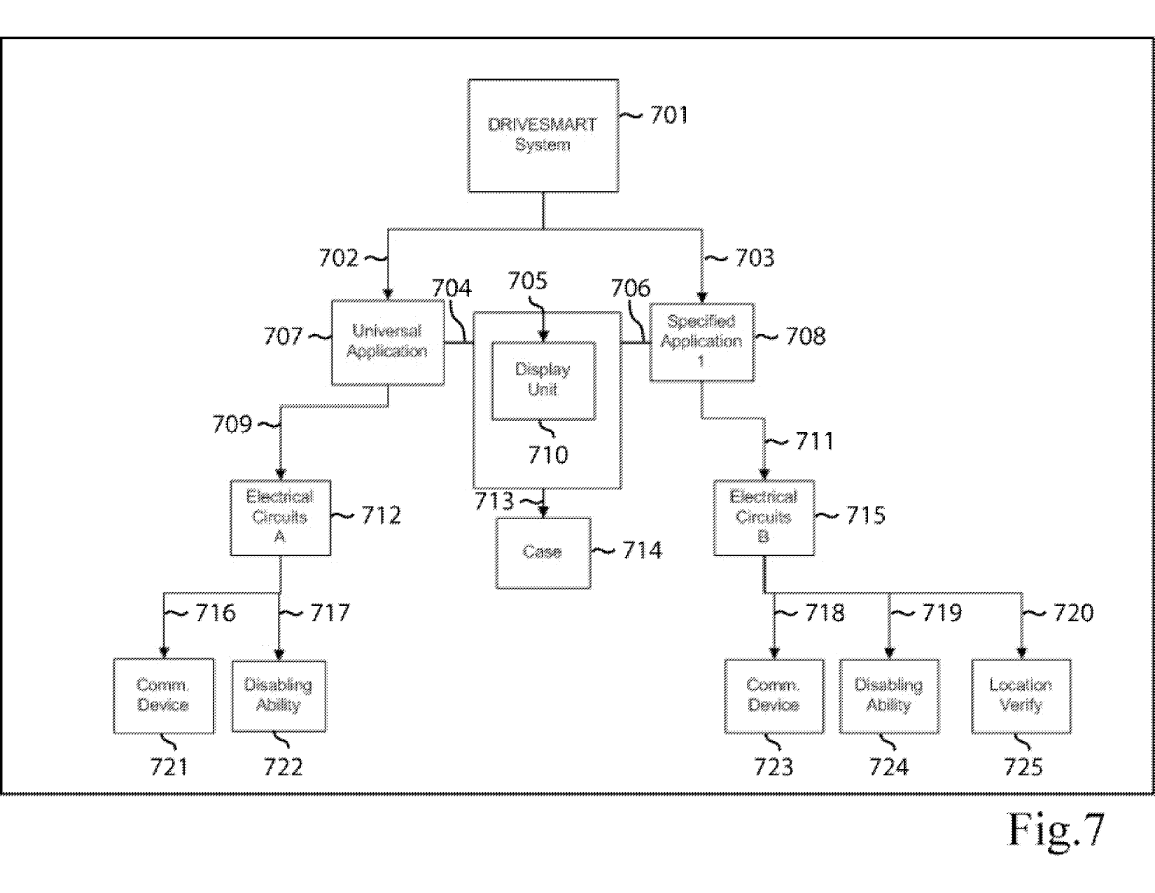

FIG. 7 illustrates the various applications of the DRIVESMART system 701 as well as their capabilities. 702 and 703 are separators to show two implementations 707 and 708. 707 is a general application that can be used for any vehicle. 708 is one of the systems that are implemented for specific applications. Lines 704 and 706 show what all the applications have in common, this is the display unit 710. 709 and 711 show that there are electrical systems, 712 and 715, involved in 707 and 708. 712 utilizes a communication device 721 and has disabling ability 722 and contains these through 716 and 717. Similar to 712, 715 utilizes a communication device 723, disabling ability 724, and a location verify capability 725, and all of these systems are connected to 715 via 718, 719, and 720.

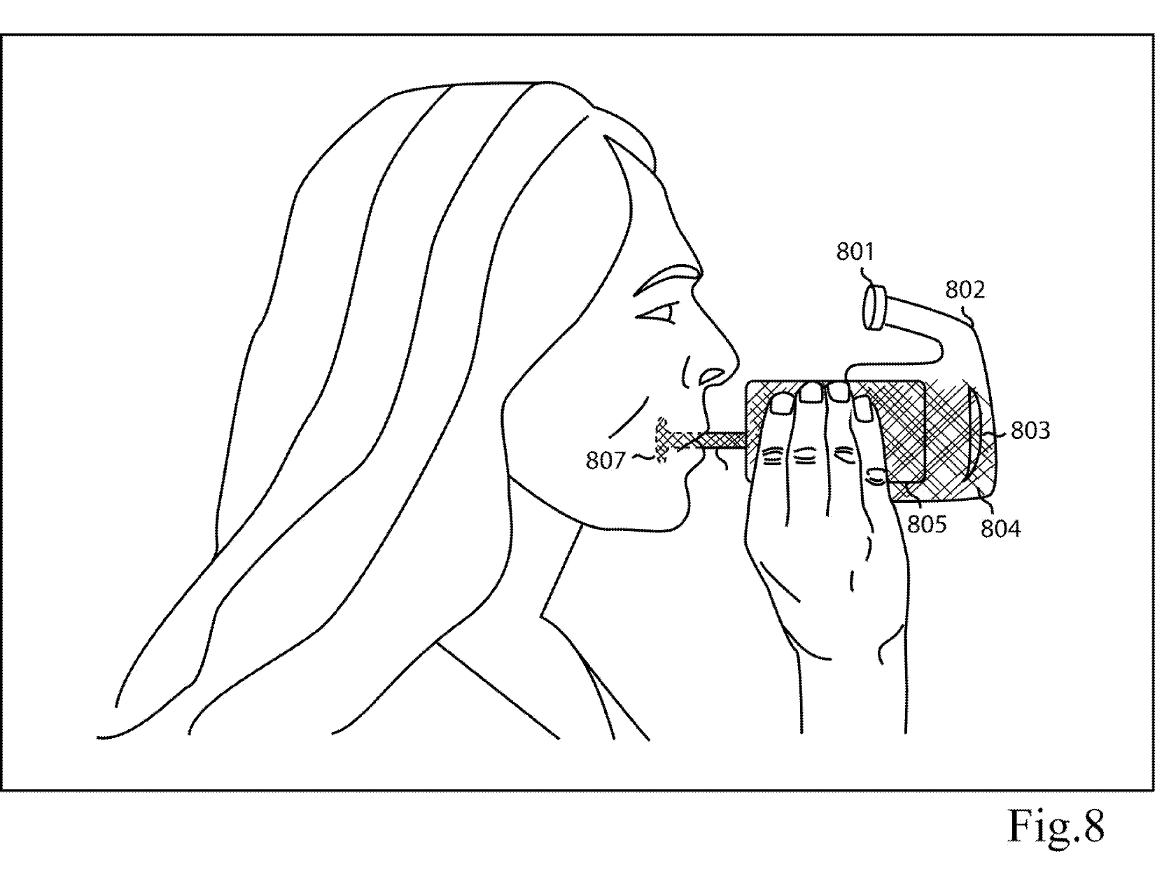

FIG. 8 illustrates an operator blowing into the mouth piece 807 connected to the first device 802 comprising a blue tooth device housed at the rear of the second device 802 that transmits a signal to a plurality of sensors 904-906 that sets forth a signal that is compared to a baseline signal housed in a cache system connected to the blue tooth system 804 wherein a distance measure compares the two analyzed signals to determine whether the operator is indeed the operator of the signal housed inside the blue tooth 803. The camera 801 is a connected to an biometric unit (biometric sensor) for facial recognition, and iris or ocular biometric recognition, which determines the identity of the operator comparing the measurements to a matrix of distance measures away from the baseline recognition system housed in memory in 802. The fingers of the operator set forth on the first device 805 creates a fingerprint metric (biometric sensor) that is sent to a finger-print recognition methodology housed in memory and processed by the processor in the first system 805. When the operator blows in to the mouthpiece 807 and air travels down the tube 808 in to the breathalyzer housed in the second device 804 a level of alcohol and/or narcotics is determined by the analyzer housed in the second device 804. Upon receiving the facial verification, the slap fingerprint verification and the Bluetooth signal analysis, the system sets forth a summation figure providing the confidence level that the operator is indeed the operator assigned to the system. Secondly it transmits both the level or non-level of narcotics and alcohol in the gas blown in to the tube 808 together with the summation of confidence to the aforementioned summation of confidence to the first system which in turn adds this new data to the original biometric data set forth in the first set of tests. Once the two sets of tests are computed together an output is transmitted from the first device to the interlock ignition system either authorizing the system to start the operators motorized vehicle or conversely to notify authorities that 1) the operator is not the operator and therefore the system will not start the engine or 2) the level of alcohol or narcotics in the gas together with the biometric tests predicts that the operator is probably not in a condition to operate a motorized vehicle or 3) the operator has tried to tamper (tamper sensor) with the second device causing the mesh 804 to break it's electrical circuit (tamper signal). In any of the three or four mentioned circumstances police authorities, guardians, parents, owners of rented motor vehicles or any person desiring to not allow said operator to operate said motor vehicle while not sober will be notified by a telephone, text or email message (communication module) wherein they may immediately call the operator on said first device 805 and immediately know the longitudinal and latitudinal GPS location of the operator and the disabled vehicle via GPS transmission from same first device 805.

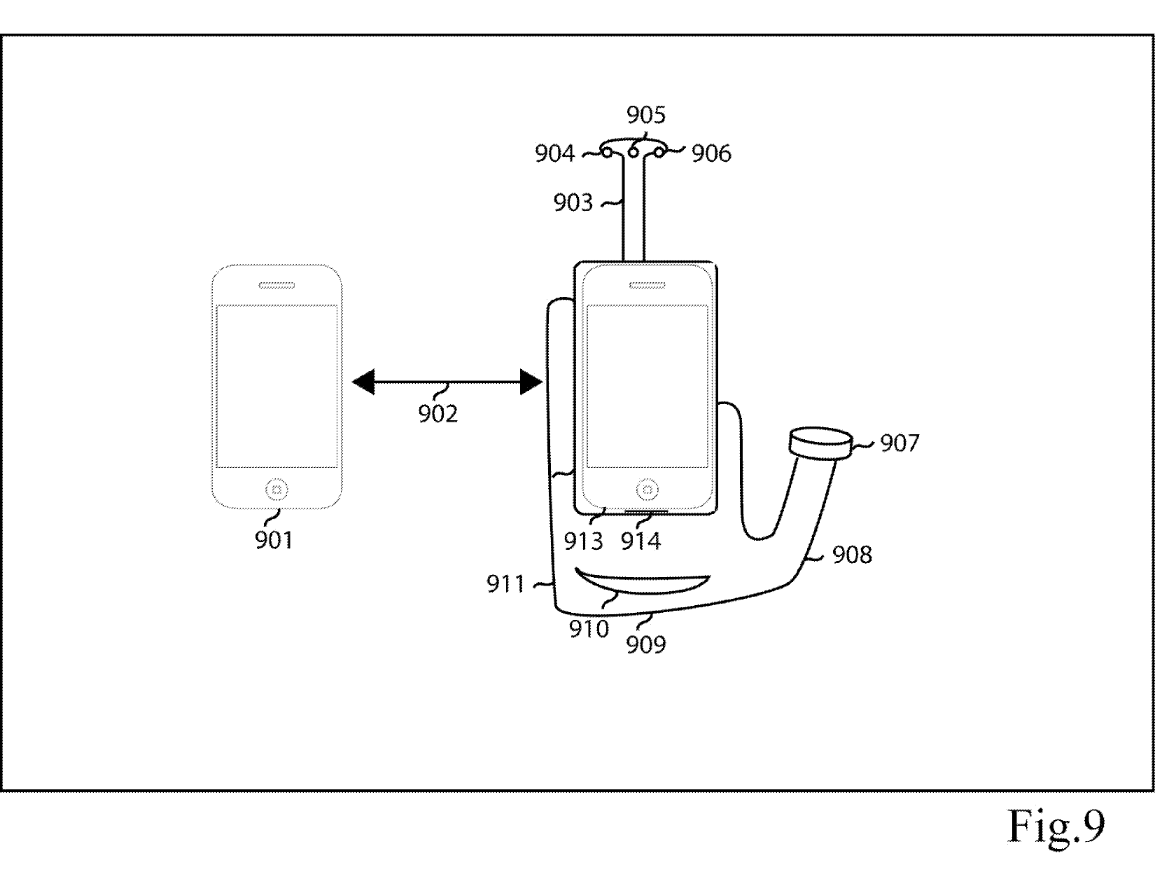

FIG. 9 illustrates said first device 901 in a stand alone position and in a preferred embodiment wherein 901 is connected with second device 908 via the arrow 902. The interlocking device 914 connects electrical circuitry to and from first system 901 to second system 908. A camera lens 907 is connected to the upper portion of second device 908 which has an outer shell 909 wherein it's inner face houses a mesh 909 connected to a plurality of transistors inside second device 908. The Bluetooth system 910 housed at the back of second device 908 transmits signals to and from a plurality of sensors 904-906 located around the mouth piece of the tube 903.

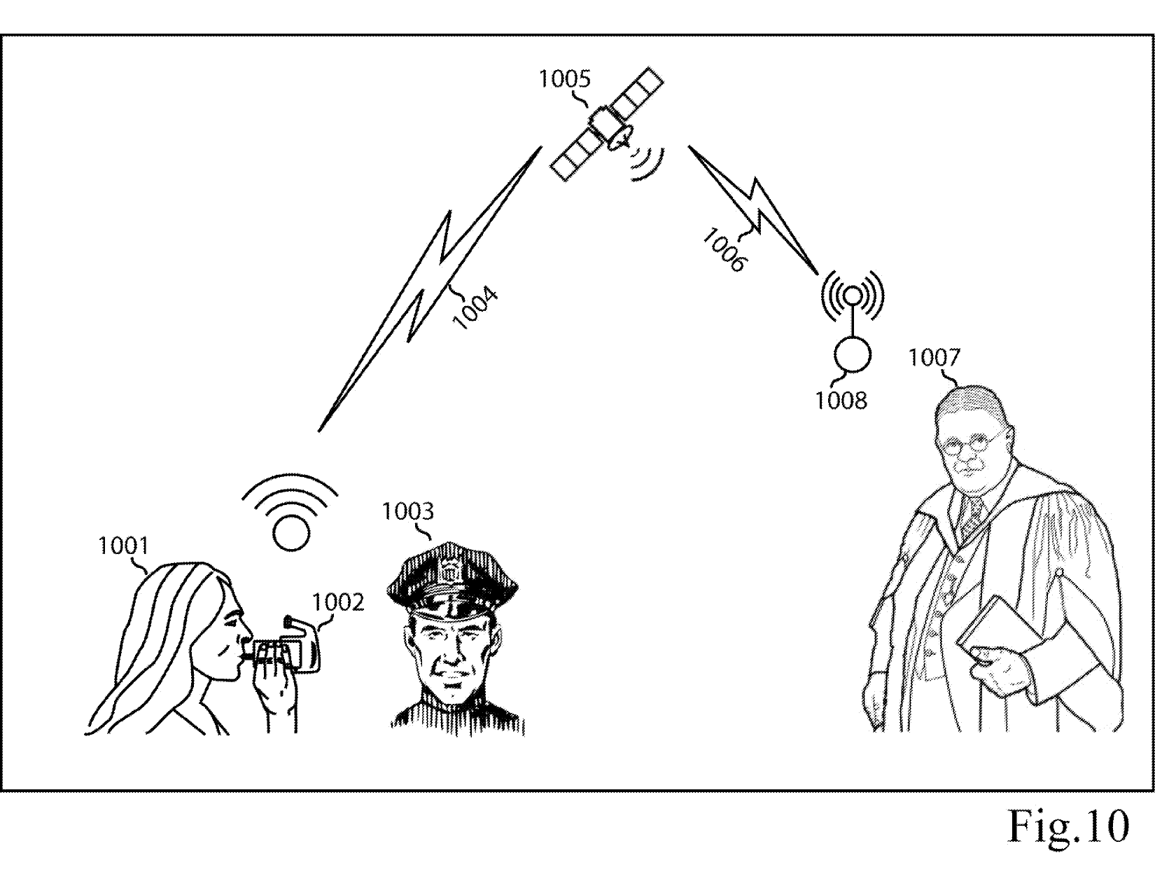

FIG. 10 illustrates a preferred embodiment of the invention 1002 wherein a 3rd party 1003 with requisite authority has ordered the operator 1001 to take the portion or of the invention including but not limited to fingerprint biometrics, facial biometrics, breathalyzer biometrics and functionality biometrics. The resultant identification and biometric results are transmitted 1004 to a satellite 1005 if necessary, and transmitted 1006 to the local receiver 1008 connected to the requisite law enforcement or guardianship authority 1007 where a determination is made who the operator is and whether the operator has violated a threshold of intoxication specific for the community as a whole or the specific parole rulings or DUI ruling on of the operator 1001.

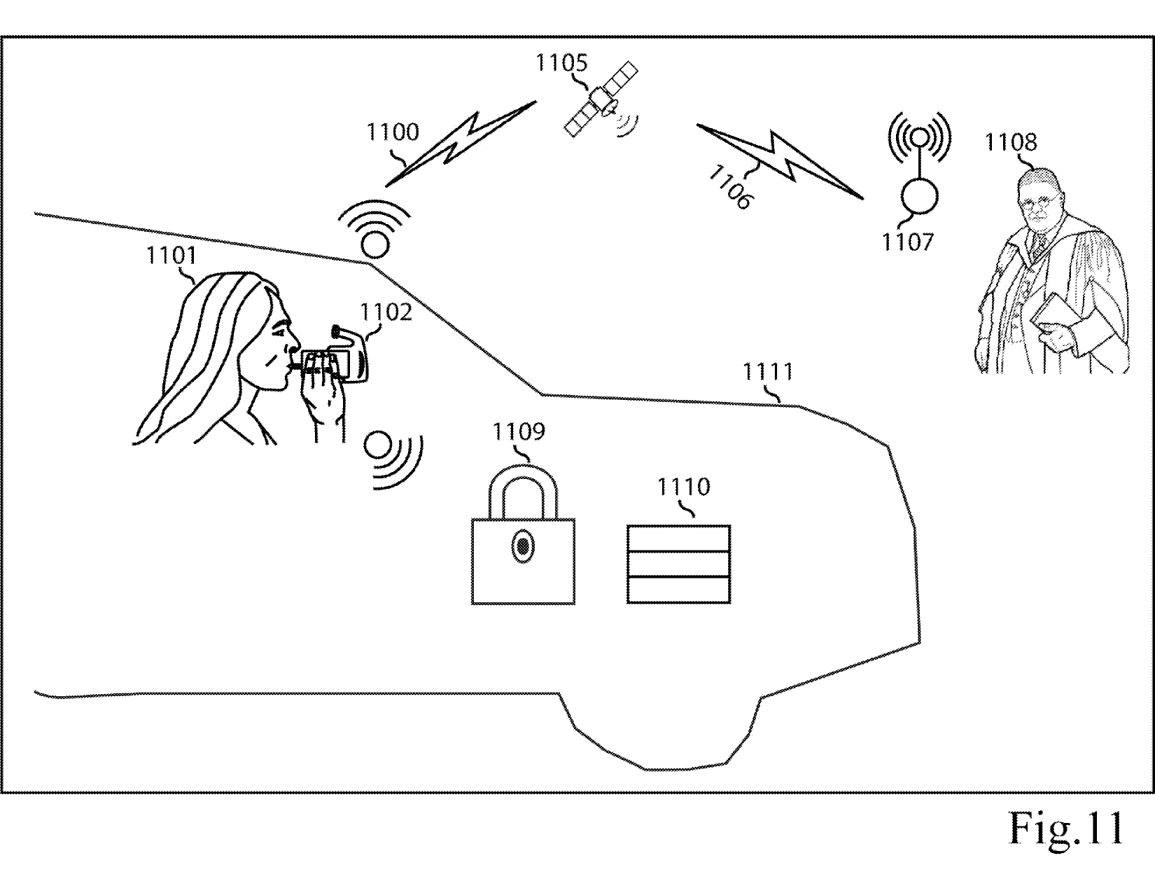

FIG. 11 illustrates a preferred embodiment of the invention 1102 wherein the operator's 1101 biometrics control both the engine ignition 1109 connected to the engine 1110 of the operator's vehicle 1111 and the transmission of the operator's impairment level rendering the vehicle 1111 unable to start and the transmission of the operator's 1101 identity and biometrics including but not limited to fingerprint biometrics, facial biometrics, breathalyzer biometrics and functionality biometrics. The resultant identification and biometric results are transmitted 1100 to a satellite 1105 if necessary, and transmitted 1106 to the local receiver 1107 connected to the requisite law enforcement or guardianship authority 1008 where a determination is made who the operator is and whether the operator has violated a threshold of intoxication specific for the community as a whole or the specific parole rulings or DUI ruling on of the operator 1001. Furthermore the location of the vehicle 1111 is readily available to the law enforcement persons.

In the preferred embodiment, the impairment measurement unit provides c test of both cognitive skills and motor coordination that are adaptive and allow operator to efficiently demonstrate their impairment measurement are normal and to start the vehicle with fewer measurements required. At higher risk times of day or when the operator's performance on the first components of the impairment measurements appear degraded, the system would require increased testing to obtain a more accurate assessment of potential mental impairment. Logically, one measurement approach would be directly measuring the reaction time and driving accuracy in a driving simulation game, which would directly relate the measured actions of the operator to the desired goals of operating the vehicle. But this is likely to be relatively insensitive without a long driving simulation because driving is a complex activity with many dimensions for stimulus/response pairing, with limited realistic stimulus display rates. It also requires complex hardware if the simulation is to be even reasonably related to actual driving. Lowe cost, more focused and sensitive testing such as divided attention cognitive tests with fine-motor skills can provide enhance sensitivity in the impairment measurement in a shorter test. In addition to stopping drunk driving it would be useful in preventing driving under the impairment of other drugs, as well as people at work operating equipment under an influence. It could also help reduce driving with sleep deprivation, and may be useful with elderly drivers whose potential driving performance may depend on many factors not related to alcohol impairment. If the DRIVESMART is implemented as part of a standard vehicle option, such as, but not limited to, a navigation system/GPS, or if it is on the operators mobile phone, then there no stigma attached, as it is not be visible as a separate interlock just for DUI prevention 114.

In another preferred embodiment of the invention, the invention comprises a turn-key aftermarket add-on to vehicles where the interface component integrates with common peripherals devices such as, but not limited to, a navigation system, other vehicle computer interfaces, portable games systems or cell phones. Integration with existing devices would allow reduced added costs as these optional display devices already have a sufficiently powerful computing engine and have a display suitable for the display of the tests. In both embodiments listed above, there arises the desire to ensure it truly is the driver that is taking the tests. Because of this, a location verification unit is necessary 102. There are several ways to accomplish this task. The first of which is to build this extra module as a wireless enabled device. By using signal strength, the rough location of the operator can be determined, and if the location is anywhere other than the driver seat, it is assumed they are not the driver of the vehicle and are not allowed to play the games until the signal strength is within a certain value matching the area in which the driving occurs. Though wireless is preferred, another embodiment would be to utilize the “weight” sensors found in vehicles with SRS airbags.

In another embodiment a impairment measurement unit and graphical operator interface, which can be installed on an electronic embodiment with sufficient processing capability, including but not limited to an automobile GPS navigation unit or a smart phone, evaluates possible mental impairment of the driver/operator through a series of impairment measurement tests. Operator interaction with the impairment measurement unit/tests can be achieved in various possible ways including but not limited to the preferred embodiment's standard input interface (e.g. keypad, touch screen, etc), a traditional mouse pad, and on newer vehicles, it could use the vehicle's standard operational equipment such as steering wheel, brakes and accelerator pedals. The impairment measurement unit allows the administrator to create operator profiles with operational identification number for each driver and also set a threshold score for each profile 109. The profile may be tied to a particular interface device, e.g. with each of multiple family members having their own profile tied to their phone. This allows the flexibility of setting different expected responses/reaction times, and different policies for different drivers. An elderly driver might demonstrate slower reaction time or greater difficulty in divided attention tasks than a young driver, but the system can transform the responses into a consistent impairment measurement score which does not indicate any potential mental impairment. A driver/operator can start the test after authenticating his/her identity. The identification may be a simple pin/password. In a preferred embodiment, the identification can be based on a biometric identification or a revocable biometric pseudo-identity token. Based on the transform of the test measurement into a impairment score (whether it reaches threshold score or not), the impairment measurement unit utilizes the embodiment's communication facility (wired or wireless) to signal the vehicle-disabling unit 113. The impairment measurement process is adaptive and may allow operators that quickly demonstrate standard impairment levels, especially at less risky times of day, to start the vehicle rather quickly. At higher risk times of day or when the operator's performance on the first components of the impairment measurement testing shows possible degraded performance, the system would require increased testing to obtain a more accurate assessment of potential mental impairment.

In a non-interlock preferred embodiment, the impairment measurement unit can be a portable device such as PDA or cell phone, with the appropriate measurement/transforms. This could be used for road-side testing, spot impairment testing at work or school, for organizational monitoring of individuals or even for self-monitoring. In this embodiment the device would not require the communication with the authentication unit, vehicle or the vehicle disabling (202, 203,204,205, 13)) which could reduce system complexity and cost. In other embodiments, communications can be useful for external reporting or storage of test results. Some embodiments could include the authentication unit (e.g. biometrics) for non-repudiation, e.g. so the operator could later prove to whom the test was administered or to validate the person who administered the test.

The initial impairment measurement unit prototype was developed using C/C++ and Java programming languages and a GUI library suitable for embedded devices such as PDA, smart phone, GPS navigation unit, etc. Other means of development could be used as long as they provide means for displaying items in the impairment tests and measuring driver responses and reaction times and computing the score from those measurements. The impairment measurement unit can be embedded in many systems using code cross-compiled based on the target system specification (operating system and processor family) where it has to be installed.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

### REFERENCES

(1) “Fatality Facts.” Insurance Institute For Highway Safety. Access: Sep. 27, 2008 <http://www.iihs.org/research/fatality_facts_{—}2006/default.html>
(2) Robert J. Kosinski. “A Literature Review on Reaction Time.” September 2008: Pgs 1-18. Clemson Biology Database. Clemson University Library, Clemson, S.C. Sep. 27, 2008 <http://biology.clemson.edu/bpc/bp/Lab/110/reaction.htm#Kinds>
(3) Cameron, E., Sinclair E. and Tiplady, B. (2001) Validity and sensitivity of a pen computer battery of performance tests, Journal of Psychopharmacology 15(2) (2001) pages 105-110.
(4) Ferrara S. D., Zancaner S., Giorgetti, R, (1994) Low blood alcohol concentrations and driving impairment: A review of experimental studies and international legislation. Int. J. Leg Med 106:169-177
(5) Mattila M J, Aranko K, Mattila M E, Paakkari I (1994) Effects of psychotropic drugs on digit substitution: comparison of the computerized symbol-digit substitution and traditional digit-symbol substitution tests. Journal Psychopharmacology 8: 81-87
(6) Moskowitz H, Burns M M, Williams A F (1985) Skills performance at low blood alcohol levels. J. of Stud. Alcohol 46:482-485
(7) Marks, D. F. and MaeAvoy, M. G. (1989) Divided attention performance in cannabis operators and non-operators following alcohol and cannabis separately and in combination, Journal of Psychopharmacology(1989)99:397-401
(8) COUPER, Fiona J. and LOGAN, Barry K (2004) Drugs and Human Performance Fact Sheets, Technical Report, DOT HS 809 725, http://www.nhtsa.gov/people/injury/research/job185drugs/drugs_web.pdf
(9) Moskowitz, H. Fiorentino, D. A Review of the Literature on the Effects of Low Doses of Alcohol on Driving-Related Skills. Technical Report DOT HS 809 028, http://www.nhtsa.gov/people/injury/research/pub/hs809028/Title.htm

What is claimed is:

1. An electrical circuit and transmission system for preventing impaired operators from activating a motorized vehicle housing an ignition disabling system comprising:
an impairment measurement unit for determining an impairment score of the operator,
an authentication module for determining an identity of the operator having an authentication signal,
a system controller receiving the impairment score and the authentication score and generating an ignition signal based on the impairment score and the authentication score, and
an ignition control system receiving the ignition signal.

2. The system of claim 1, wherein the authentication module includes a biometric sensor.

3. The system of claim 1, wherein the system controller compares the impairment score to a threshold.

4. The system of claim 1, further including a tamper sensor transmitting a tamper signal to the system controller.

5. The system of claim 3, wherein the impairment measurement unit includes one or more neuropsychological tests.

6. The system of claim 5, wherein the one or more neuropsychological test include a divided attention test.

7. The system of claim 5, wherein the impairment measurement unit stores an operator specific base-line state.

8. The system of claim 6, wherein the authentication module includes a password verification module.

9. The system of claim 1, wherein the authentication module includes a location verification unit.

10. The system of claim 1, further including a GPS (Global Position System) transmitting a location signal to the system controller.

11. The system of claim 10, further including a communication module coupled to the system controller.

12. A system for measuring and reporting an operator's impairment level comprising:
a graphical display unit;
a processor coupled to the graphical display unit an input interface coupled to the processor;
an impairment measurement module running on the processor determining an impairment score using at least one divided attention test; and
a communication module coupled to the processor and receiving the impairment score.

13. The system of claim 12, further including an authentication module, transmitting authentication data to the communication module.

14. The method of claim 13, further including the step of transmitting the impairment score to a third party.

15. A method for measuring an operator's impairment level, comprising the steps of:
testing an identity of an operator;
when the identity of the operator is valid, testing the impairment level of the operator to determine a test result;
comparing the test result to an operator specific base-line state to form an impairment score; and
when the impairment score of the operator is above a threshold, transmitting an operator-impaired signal.

16. The method of claim 15, wherein the step of testing the identity of the operator includes the step of verifying a location of the operator.

17. The method of claim 15, wherein the step of testing the identity of the operator includes the step of using a biometric sensor.

18. The method of claim 15, further including the step of receiving the operator-impaired signal at an ignition system.

19. The method of claim 15, further including the step of transmitting the operator-impaired signal to a third party.

20. The method of claim 15, wherein the step of testing the impairment level combines a plurality of neuropsychological tests and physiological tests.
